(19) United States
(12) Patent Application Publication
(10) Pub. No.: US 2011/0101917 A1
(43) Pub. Date: May 5, 2011

(54) BATTERY PACK

(76) Inventors: Whan-Seok Doh, Yongin-si (KR); Jin-Hong An, Yongin-si (KR); No-Hyun Kwag, Yongin-si (KR); Kyung-Won Seo, Yongin-si (KR)

(21) Appl. No.: 12/912,660

(22) Filed: Oct. 26, 2010

(30) Foreign Application Priority Data
Nov. 3, 2009 (KR) 10-2009-0105488

(51) Int. Cl. H02J 7/00

(52) U.S. Cl. 320/116

(57) ABSTRACT

A battery pack includes a case including external terminals, batteries disposed in the case, and balancing lines connected to each of the batteries and functioning as pathways of a voltage signal transmitted to a controller. At least one of the balancing lines functions as a high current line supplying battery current to the external terminals. Thus, the battery pack may have a simple structure and may be simply assembled using the high current line as a balancing line.

### CROSS-REFERENCE TO RELATED APPLICATION

This application claims the benefit of Korean Patent Application No. 10-2009-0105488, filed Nov. 3, 2009 in the Korean Intellectual Property Office, the disclosure of which is incorporated herein by reference.

### BACKGROUND

1. Field

One or more embodiments of the present invention relate to a battery pack including a plurality of batteries connected to each other.

2. Description of the Related Art

A battery pack is a power supply unit manufactured by connecting a plurality of batteries. For example, the battery pack may be employed in a large capacity power supply device, such as an uninterruptible power supply (UPS) and may be used to supply power when a power failure occurs. The battery pack can be used instead of the large capacity power supply device.

Since the battery pack includes a plurality of batteries as described above, balancing lines protruding from each of the batteries are connected to a connector. The connector is connected to a controller to stably operate the batteries, so that voltage states of each of the batteries are monitored. For this, the balancing lines are respectively connected to each of the batteries in the pack, which complicates the assembly of the battery pack.

### SUMMARY

One or more embodiments of the present invention include a battery pack manufactured using a simple balancing line connection process.

According to one or more embodiments of the present invention, a battery pack includes a case including external terminals, a plurality of batteries disposed in the case, and balancing lines connected to each of the batteries and functioning as pathways of a voltage signal transmitted to a controller, wherein at least one of the balancing lines functions as a high current line supplying battery current to the external terminals.

According to an aspect of the invention, one end of each of the balancing lines may be connected to each of the batteries, and the other end of each of the balancing lines may be connected to a connector disposed in the case to which the controller is connected.

According to an aspect of the invention, the balancing line that also functions as a high current line may be thicker than the rest of the balancing lines.

According to an aspect of the invention, the balancing line that also functions as a high current line may be longer than the rest of the balancing lines.

According to an aspect of the invention, the battery pack may further include a resistor for reducing a current supplied to the controller via the balancing line that also functions as a high current line.

The battery pack according to an embodiment of the present invention may have a simple structure and may be simply assembled using a high current line as a balancing line.

Additional aspects will be set forth in part in the description which follows and, in part, will be apparent from the description, or may be learned by practice of the presented embodiments.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 schematically shows a structure of a battery pack according to an embodiment of the present invention; and

FIG. 2 schematically shows a structure of a battery pack according to another embodiment of the present invention.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

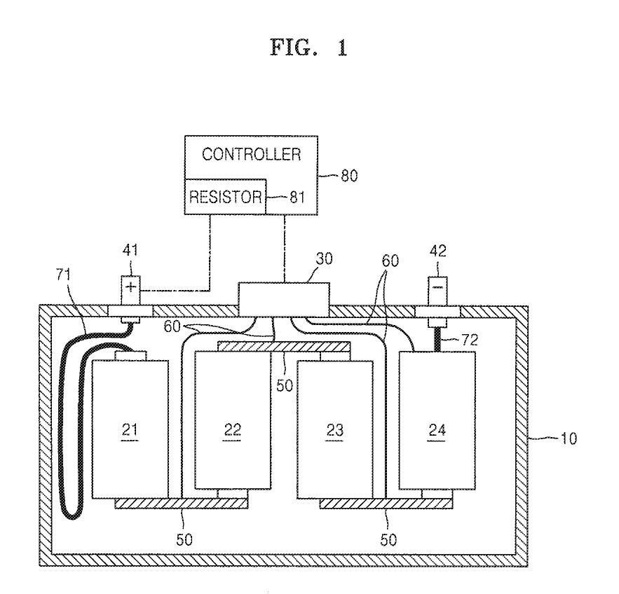

FIG. 1 schematically shows a structure of a battery pack according to an embodiment of the present invention. Referring to FIG. 1, the battery pack includes a case 10 including positive and negative electrode external terminals 41 and 42 and a connector 30 connected to a controller 80. A plurality of batteries 21, 22, 23, and 24 are in the case 10. Electrode tabs 50 connect the batteries 21, 22, 23, 24 in series. Specifically, an electrode tab 50 connects the plurality of batteries 21, 22, another electrode tab 50 connects batteries 22, 23, and a further electrode tab 50 connects batteries 23, 24.

Balancing lines 60 are connected to the connector 30 in order to transmit voltage signals of the batteries 22, 23, and 24 to the controller 80. One balancing line 60 is connected at one end to the tab 50 between the batteries 21, and 22 and at the other end to the connector 30. Another balancing line 60 is connected at one end to the tab 50 between the batteries 22, 23 and at the other end to the connector 30. Another balancing line 60 is connected at one end to the tab 50 between the batteries 23, 24 and at the other end to the connector 30. Another balancing line 60 is connected directly to the battery 24. Thus, the balancing lines 60 connect the connector 30 to the batteries 22, 23, 24 in order to transmit voltage signals of the batteries 22, 23, and 24 to the controller 80 directly or via the corresponding electrode tabs 50.

High current lines 71 and 72 supply current of the plurality of batteries 21, 22, 23, and 24 to the corresponding positive and negative electrode external terminals 41 and 42. The high current line 71 supplies the current to the positive electrode external terminal 41, and the high current line 72 supplies the current to the negative electrode external terminal 42.

As shown, the plurality of batteries 21, 22, 23, and 24 embedded in the case 10 are connected in series by the electrode tab 50. The total current of the batteries 21, 22, 23, and 24 connected in series is supplied to the positive and negative electrode external terminals 41 and 42 via the high current lines 71 and 72. The voltage signals of each of the batteries 22, 23, and 24 are transmitted to the connector 30 through the balancing lines 60, and then to the controller 80.

As shown, the high current line 71 is connected to the positive electrode external terminal 41 and also functions as a balancing line. That is, each of the batteries 22, 23, and 24 has its own exclusive balancing line 60. However, the last battery 21 at one end of the battery pack, which is connected to the positive electrode external terminal 41, does not have its own exclusive balancing line 60. Instead, the high current line 71 functions as the balancing line as well as providing the current to the terminal 41. Thus, the voltage signal of the battery 21 is transmitted to the controller 80 through the high current line 71, and the controller 80 receives the signal to monitor the voltage states of the battery 21. As shown, a connection is made, such as through wires, between the connector 30 and the controller 80 in order to transmit the voltage signals of the batteries 22, 23, 24 to the controller 80. A separate connection is made between the controller 80 and the external terminal 41, such as using a wire, to transmit the voltage signal transmitted through the high current line 71.

While not required in all aspects, the balancing lines 60 generally have a relatively high resistance since they are thin and current from only the batteries 22, 23, and 24 flows in the balancing lines 60. Thus, a current flowing in each of the balancing lines 60 is, for example, only about 5 mA. In contrast, the high current line 71 has relatively low resistance since it is thick and the total current flows in the high current line 71. Thus, a current flowing in the high current line 71 is, for example, about 30 A. That is, there is a large difference between the currents flowing in the balancing lines 60 and the total current flowing in the high current line 71. As such, a resistor 81 is disposed in the controller 80 to account for this difference. Using the resistor 81, the current supplied through the high current line 71 to the controller 80 is reduced to a current level similar to that of the balancing lines 60. This prevents a difficulty in processing the balancing signals caused by the current difference may be overcome. While not required in all aspects, the controller 80 can be at least one processor implementing instructions encoded as software or firmware on computer readable media.

However, it is understood that other mechanisms can be used to prevent the difficulty in processing the balancing signals without using the resistor 81 or having the resistor 81 incorporated into the controller 80 as shown. For instance, if the high current line 71 does not have a linear shape but is elongated as shown in FIG. 1, relative resistance increases, and thus the current difference may further be reduced. As such, the resistor 81 need not be used in all aspects of the invention. Alternately, the properties of the balancing lines 60 (such as the thickness) can be changed to reduce the relative differences in the resistance levels.

According to this structure, the balancing lines 60 are not required to be installed for every battery. Since the high current line 71 is used for the last battery 21, the battery pack may have a simple structure and may be simply assembled. In other words, generally, the same number of balancing lines 60 as that of the batteries is welded in the compact case 10. However, in the battery pack, the balancing line for the last battery 21 does not have to be welded so that the case 10 may have more space and other processes may efficiently be performed. Thus, a battery pack having a simple structure and simply assembled may be manufactured. The high current line 71 that also functions as a balancing line may be used as a high current line while high current is consumed and as a balancing line while the high current is not consumed.

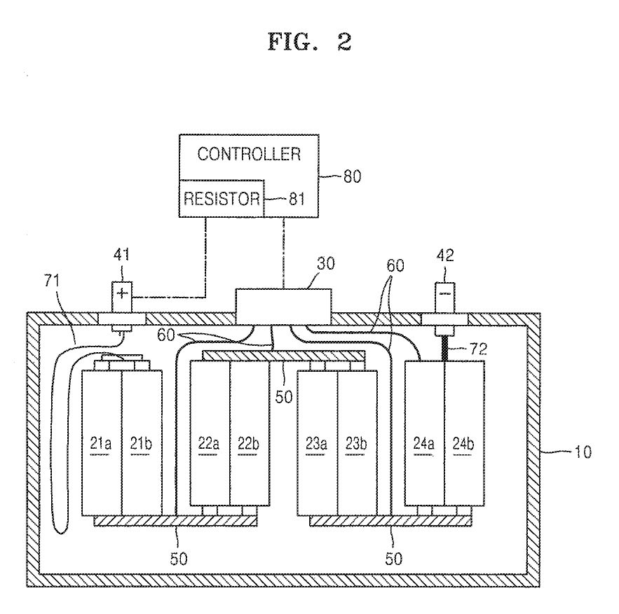

FIG. 2 schematically shows a structure of a battery pack according to another embodiment of the present invention. Like reference numerals in FIGS. 1 and 2 denote like elements. Although the batteries 21, 22, 23, 24 are connected in series in the embodiment shown in FIG. 1, the batteries 21a and 21b, 22a and 22b, 23a and 23b, and 24a and 24b are connected in parallel and series in the shown embodiment.

That is, there are four battery units. Each battery unit includes two batteries connected in parallel. In the shown example, a last battery unit includes batteries 21a and 21b, a third battery unit includes batteries 22a and 22b, a second battery unit includes batteries 23a and 23b, and a first battery unit includes batteries 24a and 24b. The battery units are connected in series by the electrode tabs 50. Specifically, one electrode tab 50 connects the last and third battery units, another electrode tab 50 connects the second and third battery units, and a further electrode tab connects the first and second battery units.

The balancing lines 60 protruding outward from corresponding tabs 50 of the battery units are connected to the connector 30. Specifically, one balancing line 60 connects the electrode tab 50 between the last and third battery units to the connector 30; another balancing line 60 connects the electrode tab 50 between the second and third battery units to the connector 30; a further balancing line 60 connects the electrode tab 50 between the second and first battery units to the connector 30; and another balancing line 60 connects the first battery unit to the connector 30. The last battery unit having batteries 21a and 21b is directly connected to the positive electrode external terminal 41 via the high current line 71 such that the high current line 71 also functions as a balancing line so as to transmit signals to the controller 80.

According to the shown embodiment, the connection structures of the balancing lines 60 and the high current line 71 are the same as those described above in the embodiment shown in FIG. 1, and the battery units may be connected in parallel and in series instead of being connected only in series. Here, the current difference between the balancing lines 60 and the high current line 71 may also be reduced by disposing the resistor 81 in the controller 80 and/or elongating the high current line 71 that also functions as a balancing line and is relatively thick.

Thus, a battery pack having a simple structure and that is simply assembled may also be manufactured. According to the current embodiment, two batteries are connected in parallel to constitute a battery unit, and four battery units are connected in series. However, the number of batteries connected in parallel and in series may vary if desired.

Meanwhile, although a line connecting the positive electrode external terminal 41 and the last battery 21 or the last battery unit is referred to as the high current line 71, it may also be referred to as a balancing line that functions as a high current line.

In addition, although the positive electrode external terminal 41 is connected to the last battery 21 or the last battery unit at one end of the battery pack by the high current line 71, the negative electrode external terminal 42 may also be connected to the last battery 24 or the last battery unit at the other end of the battery pack by any high current line 72 that also functions as a balancing line. Further, it is also possible that both high current lines 71 and 72 could be used as balancing lines, further reducing the number of balancing lines 60.

As described above, the battery pack according to the one or more of the above embodiments of the present invention has a simple structure and may be simply assembled using the high current line that also functions as a balancing line.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A battery pack for use with a controller monitoring voltage states, the battery pack comprising:
a case comprising external terminals;
a plurality of batteries disposed in the case which supply battery current to the external terminals; and
balancing lines connected to the batteries and functioning as pathways of a voltage signal transmitted to the controller monitoring the voltage states of the batteries,
wherein at least one of the balancing lines comprises a high current line supplying the battery current to one of the external terminals while functioning as the pathway of the voltage signal transmitted from at least one of the batteries to the controller.

2. The battery pack of claim 1, further comprising a connector disposed at the case and which is connected to the controller, wherein for each of the balancing lines other than the one balancing line, one end is connected to a corresponding one of the batteries, and the other end is connected to the connector.

3. The battery pack of claim 1, wherein the one balancing line is thicker than the remaining ones of the balancing lines.

4. The battery pack of claim 1, wherein the one balancing line is longer than the remaining ones of the balancing lines.

5. The battery pack of claim 1, further comprising a resistor which reduces a current supplied to the controller via the high current line of the one balancing line.

6. The battery pack of claim 1, wherein the at least one balancing line connects the one battery to the one external terminal.

7. The battery pack of claim 1, further comprising the controller and a wire connecting the controller to the one external terminal to supply the voltage signal transmitted from the one battery to the controller.

8. The battery pack of claim 7, further comprising a connector disposed at the case and which is connected to the controller, wherein for each of the balancing lines other than the one balancing line, one end is connected to a corresponding one of the batteries, and the other end is connected to the connector.

9. The battery pack of claim 7, further comprising a resistor connected to the wire and which reduces a current received by the controller.

10. The battery pack of claim 9, wherein the reduced current produced by the resistor is substantially the same as a current in each of the remaining balancing lines.

11. The battery pack of claim 1, at least two of the batteries are connected in parallel to form a battery unit, and at least one of the balancing lines is connected to the battery unit.

12. A battery pack comprising
batteries which supply a battery current;
a high current line connected to one of the batteries and supplying the battery current and supplying one voltage signal; and
balancing lines connected to corresponding remaining ones of the batteries to transmit corresponding remaining voltage signals,
wherein:
the balancing lines are connectable to a controller through a first pathway to receive the remaining voltage signals of the remaining batteries to monitor a state of each of the remaining batteries, and
the high current line is connectable to the controller through a second pathway to provide the one voltage signal to monitor a state of the one battery.

13. The battery pack of claim 12, further comprising a connector connected to each of the balancing lines and which is connectable to the controller to form the first pathway.

14. The battery pack of claim 12, wherein the high current line is thicker than each of the balancing lines.

15. The battery pack of claim 12, wherein the high current line is longer than each of the balancing lines.

16. The battery pack of claim 12, further comprising a resistor which reduces a current supplied to the controller via the high current line.

17. The battery pack of claim 12, further comprising an external terminal through which the battery current is supplied to an external load, wherein the high current line connects the one battery to the external terminal.

18. The battery pack of claim 17, further comprising a wire connecting the controller to the external terminal to supply the one voltage signal transmitted from the one battery to the controller to form the second pathway.

19. The battery pack of claim 18, further comprising a resistor connected to the wire and which reduces a current received by the controller.

20. The battery pack of claim 12, at least two of the batteries are connected in parallel to form a battery unit, and at least one of the balancing lines is connected to the battery unit.
